(19) United States
(12) Patent Application Publication
(10) Pub. No.: US 2005/0075470 A1
(43) Pub. Date: Apr. 7, 2005

(54) Self-crosslinking polyurethane dispersions

(76) Inventors: Jan Mazanek, Koln (DE); Jurgen Meixner, Krefeld (DE); Olaf Fleck, Bergisch Gladbach (DE); Heino Muller, Leverkusen (DE)

Correspondence Address: BAYER MATERIAL SCIENCE LLC, 100 BAYER ROAD, PITTSBURGH, PA, 15205, US

(21) Appl. No.: 10/953,386

(22) Filed: Sep. 29, 2004

(30) Foreign Application Priority Data
Oct. 2, 2003 (DE) 10346548.0

(51) Int. Cl. C08G 18/00

(52) U.S. Cl. 528/44

(57) ABSTRACT

A process for preparing self-crosslinking polyurethane polymers including i) reacting an aromatic isocyanate component (A) or a mixture of aromatic, aliphatic and/or cycloaliphatic isocyanate component having an isocyanate group functionality of greater than or equal to 2 with an at least difunctional polyol component (B1) with an average molecular weight of from 62 to 2500, which includes at least one acid-functional compound (C), to give a prepolymer containing isocyanate groups or containing hydroxyl groups, ii) adding one or more polyol components (B2) having an OH functionality of greater than or equal to 1, and optionally, an isocyanate component (A′), which may be identical to or different from (A), iii) mixing the resulting NCO-functional product with a blocking agent (D), and iv) adding a polyol component (B3). Self-crosslinking polyurethane polymers prepared as described above can be used in paint, varnish or adhesive compositions.

### CROSS REFERENCE TO RELATED PATENT APPLICATION

The present patent application claims the right of priority under 35 U.S.C. §119 (a)-(d) of German Patent Application No.103 46 548.0, filed Oct. 3, 2003.

### BACKGROUND OF THE INVENTION

1. Field of the Invention

The present invention relates to aqueous self-crosslinking polyurethane (PU) dispersions, to baking enamels prepared from them and to their use in varnishes and paints, particularly in automotive OEM finishing.

2. Description of the Prior Art

Recent years have seen a sharp rise in the profile of aqueous coating materials in the wake of increasingly stringent emissions directives governing the solvents released during paint application. Although for many fields of application there are now aqueous coating systems available, these systems are often unable to attain the high quality level of conventional, solvent-borne coating materials in respect of solvent resistance and chemical resistance or else of elasticity and mechanical durability. In particular there has been no disclosure to date of any polyurethane-based coating materials that can be processed from the aqueous phase and that go far enough towards satisfying the exacting requirements of the art in automotive OEM finishing.

This appreciation applies both to DE-A 40 01 783, which deals with special anionically modified aliphatic polyisocyanates, and to the systems of DE-A 24 56 469, of DE-A 28 14 815, of EP-A 0 012 348 and of EP-A 0 424 697, which describe aqueous baking-enamel binders based on blocked polyisocyanates and organic polyhydroxyl compounds. Additionally the systems based on carboxyl-containing polyurethane prepolymers containing blocked isocyanate groups, of DE-A 27 08 611, or the blocked water-soluble polyurethane prepolymers of DE-A 32 34 590, which are of high functionality and hence are largely unsuitable for producing elastic coatings, are to a large extent not useful for the stated purpose.

Further improvements have been achieved in recent years to the one-component (1K) baking enamels used, such as in EP-A 0 576 952, in which combinations of water-soluble or water-dispersible polyhydroxy compounds with water-soluble or water-dispersible blocked polyisocyanates cyanates are described, or in DE-A 199 30 555, in which combinations of a water-dispersible, hydroxy-functional binder component containing urethane groups, a binder component which contains blocked isocyanate groups and is prepared in a multi-stage process, over two prepolymerization steps, an amino resin and further components are disclosed. A disadvantage of these one-component systems is that the components prepared in advance are then formulated to coating materials and hence require an additional mixing step.

The coating materials described in the prior art do not, however, meet all of the requirements of the art, not least in respect of the solids content and the stability of the coating materials and their reactivity, nor yet in the properties of the coatings produced from them, such as surface smoothness and gloss, and in particular not in respect of resistance to solvents and/or pendulum hardness.

It was an object of the present invention to provide improved aqueous 1K baking systems, the intention being that the coating materials based on such systems should have in particular a high solids content and relatively high reactivity and that the coatings should not only exhibit surface smoothness and gloss but also have improved resistance to solvents and/or pendulum hardness.

### SUMMARY OF THE INVENTION

The present invention is directed to a process for preparing self-crosslinking polyurethane polymers including i) reacting an aromatic isocyanate component (A) or a mixture of aromatic, aliphatic and/or cycloaliphatic isocyanate component having an isocyanate group functionality of greater than or equal to 2 with an at least difunctional polyol component (B1) with an average molecular weight of from 62 to 2500, which includes at least one acid-functional compound (C), to give a prepolymer containing isocyanate groups or containing hydroxyl groups, ii) adding one or more polyol components (B2) having an OH functionality of greater than or equal to 1, and optionally, an isocyanate component (A′), which may be identical to or different from (A), iii) mixing the resulting NCO-functional product with a blocking agent (D), and iv) adding a polyol component (B3).

The present invention is also directed to self-crosslinking polyurethane polymers prepared according to the above-described process as well as aqueous dispersion including the self-crosslinking polyurethanes.

The present invention is additionally directed to a method of preparing aqueous dispersions including neutralizing the above-described polyurethane polymers.

The present invention is further directed to paint, varnish or adhesive compositions that contain the above-described polyurethane polymers.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

The present invention provides a process for preparing self-crosslinking polyurethane polymers as a basis for such aqueous 1K baking systems, characterized in that in a first step at least one aromatic isocyanate component or a mixture of at least one aromatic, aliphatic and/or cycloaliphatic isocyanate component (A) having an isocyanate group functionality of greater than or equal to 2 is reacted with an at least difunctional polyol component (B1) with an average molecular weight of from 62 to 2 5000, which includes at least one acid-functional compound (C), to give a prepolymer containing isocyanate groups or hydroxyl groups, subsequently one or more polyol components (B2) having an OH functionality of greater than or equal to 1 and, if desired, an isocyanate component (A′), which can be identical to or different from (A), are added, the resultant NCO-functional product is admixed with a blocking agent (D) so that the isocyanate groups are partly blocked and in a further stage the non-blocked isocyanate groups are reacted with a polyol component (B3) to give a product containing hydroxyl groups

In one preferred embodiment of the invention addition of the polyol component (B3) is followed by addition in a final step of an acid-functional compound (C′), which can be identical to or different from (C), and of an isocyanate component (A″), which can be identical to or different from (A) and (A′).

In the process of the invention the ratio chosen of the isocyanate groups, including the blocked groups, to all isocyanate-reactive groups is from 0.5 to 3.0:1, preferably from 0.6 to 2.0:1, more preferably from 0.8 to 1.5:1.

The present invention likewise provides the self-crosslinking polyurethane polymers obtainable in accordance with the process of the invention, it being essential that the for preparing the prepolymer prepared in the first step already at least one aromatic isocyanate is used.

Suitable isocyanate components (A), (A′) and (A″) are aliphatic, cycloaliphatic, araliphatic and/or aromatic isocyanates having an average functionality of from 2 to 5, preferably 2, and having an isocyanate content of from 0.5 to 60% by weight, preferably from 3 to 40% by weight, more preferably from 5 to 30% by weight, such as tolylene diisocyanate (TDI), diphenylmethane 2,4′- and/or 4,4′-diisocyanate (MDI), triphenylmethane 4,4′-diisocyanate or naphthylene 1,5-diisocyanate and products with higher degrees of condensation, tetramethylene diisocyanate, cyclohexane 1,3- and 1,4-diisocyanate, hexamethylene diisocyanate (HDI), 1-isocyanato-3,3,5-trimethyl-5-isocyanatomethylcyclohexane (isophorone diisocyanate, IPDI), methylenebis(4-isocyanatocyclohexane), tetramethylxylylene diisocyanate (TMXDI), triisocyanatononane, and any desired mixtures of such isocyanates. Preference is given to aromatic polyisocyanates, particular preference to tolylene diisocyanate (TDI), diphenylmethane 2,4′ and/or 4,4′-diisocyanate (MDI) and the mixtures thereof with isophorone diisocyanate, bis(4,4-isocyanatocyclohexylmethane) and hexamethylene diisocyanate.

Of preferred suitability as an added component to the aromatic polyisocyanates of component (A), (A′) or (A″) are polyisocyanates containing heteroatoms in the radical containing the isocyanate groups. Examples thereof are polyisocyanates containing carbodiimide groups, allophanate groups, isocyanurate groups, urethane groups and biuret groups. Particularly preferred polyisocyanates in mixtures with aromatic polyisocyanates are those used primarily in the preparation of coating materials, examples being modification products containing biuret, isocyanurate or uretdione groups, for example, of the abovementioned simple polyisocyanates, particularly of hexamethylene diisocyanate or of isophorone diisocyanate.

Also suitable are low molecular weight polyisocyanates containing urethane groups, such as may be obtained by reacting TDI or MDI, employed in excess, with simple polyhydric alcohols from the molecular weight range 62 to 300, in particular with trimethylolpropane or glycerol.

Suitable polyisocyanates are additionally the known prepolymers containing terminal isocyanate groups, such as are obtainable in particular by reacting the abovementioned simple polyisocyanates, especially diisocyanates, with substoichiometric amounts of organic compounds containing at least two isocyanate-reactive functional groups. In these known prepolymers the ratio of isocyanate groups to NCO-reactive hydrogen atoms is from 1.05:1 to 10:1, preferably from 1.5:1 to 4:1, the hydrogen atoms originating from hydroxyl groups. The nature and proportions of the starting materials used in preparing NCO prepolymers are chosen such that the NCO prepolymers preferably have an average NCO functionality of from 2 to 3 and a number-average molar mass of from 500 to 10 000, preferably from 800 to 4000.

Also suitable as polyisocyanates for the purposes of the invention are those polyurethane-, polyester- and/or polyacrylate-based polymers containing free isocyanate groups, and also mixtures of such polymers if desired, in which only some of the free isocyanate groups are blocked with the blocking agents while the remainder are reacted with an excess of hydroxyl-containing polyesters, polyurethanes and/or polyacrylates and also mixtures thereof, if desired, to give a polymer which contains free hydroxyl groups and which on heating to suitable baking temperatures crosslinks without the addition of further isocyanate groups reactive groups (self-crosslinking one-component baking systems).

The polyol component (B1) comprises dihydric to hexahydric polyol components with a molecular weight of from 62 to 2500, preferably from 62 to 1000, more preferably from 62 to 500, at least one of these components being an acid-functional compound (C). Preferred polyol components are, for example, 1,4- and/or 1,3-butanediol, 1,6-hexanediol, 2,2,4-trimethyl-1,3-pentanediol, trimethylolpropane and polyester polyols and/or polyether polyols with an average molar weight of less than or equal to 1000.

The polyol component (B1) preferably contains more than 50% by volume of an acid-functional compound (C); with particular preference component (B1) comprises exclusively compound (C), with very particular preference exclusively dimethylolpropionic acid.

Suitable acid-functional compounds (C)/(C′) are hydroxy-functional carboxylic acids and/or sulphonic acids, preferably mono- and dihydroxycarboxylic acids, such as 2-hydroxyacetic acid, 3-hydroxypropanoic acid and 12-hydroxy-9-octadecanoic acid (ricinoleic acid). Particularly preferred carboxylic acids (C)/(C′) are those in which the carboxyl group is hindered in its reactivity owing to steric effects, such as lactic acid. Very particular preference is given to 3-hydroxy-2,2-dimethylpropanoic acid (hydroxypivalic acid) and dimethylolpropionic acid.

The polyol component (B2) is selected from the group consisting of
b1) dihydric to hexahydric alcohols having average molar weights of from 62 to 300, preferably from 62 to 182, more preferably from 62 to 118,
b2) linear difunctional polyols having average molar weights of from 300 to 4000, preferably from 300 to 2000, more preferably from 300 to 1000,
b3) monofunctional linear polyethers having average molar weight of from 300 to 3000, preferably from 300 to 2000, more preferably from 300 to 1000.

Suitable polyol components (b1) include dihydric to hexahydric alcohols and/or mixtures thereof which contain no ester groups. Typical examples are ethane-1,2-diol, propane-1,2- and -1,3-diol, butane-1,4, -1,2- or -2,3-diol, hexane-1,6-diol, 1,4-dihydroxycyclohexane, glycerol, trimethylolethane, trimethylolpropane, pentaerythritol and sorbitol. Naturally as component b1) it is also possible to use alcohols containing ionic groups or groups which can be converted into ionic groups.

Preference is given for example to 1,4- or 1,3-butanediol, 1,6-hexanediol and/or trimethylolpropane.

Suitable linear difunctional polyols (b2) are selected from the group consisting of polyethers, polyesters and/or polycarbonates. The polyol component (b2) preferably comprises at least one ester-group-containing diol of the molecular weight range from 350 to 4000, preferably from 350 to 2000, more preferably from 350 to 1000. The molecular weight in question is the average which can be calculated from the hydroxyl number. In general the ester diols are mixtures, which may also contain minor amounts of individual constituents having a molecular weight which is below or above these limits. The compounds in question are the polyester diols, known per se, which have been synthesized from diols and dicarboxylic acids. Suitable diols are, for example, 1,4-dimethylolcyclohexane, 1,4- or 1,3-butanediol, 1,6-hexanediol, neopentylglycol, 2,2,4-trimethyl-1,3-pentanediol, trimethylolpropane and also pentaerythritol or mixtures of such diols. Suitable dicarboxylic acids are, for example, aromatic dicarboxylic acids such as phthalic acid, isophthalic acid and terephthalic acid, cycloaliphatic dicarboxylic acids such as hexahydrophthalic acid, tetrahydrophthalic acid, endomethylenetetrahydrophthalic acid and their anhydrides, and aliphatic dicarboxylic acids, which are used with preference, such as succinic acid, glutaric acid, adipic acid, suberic acid, azelaic acid and sebacic acid or their anhydrides. Polyester diols based on adipic acid, phthalic acid, isophthalic acid and tetrahydrophthalic acid are used preferably as component (b2).

Particular preference as component (b2) is given, however, to using polycaprolactone diols of the average molecular weight range from 350 to 4000, preferably from 350 to 2000, more preferably from 350 to 1000, which have been prepared in conventional manner from a diol or mixture of diols of the type exemplified above, as starter compounds, and ε-caprolactone. The preferred starter molecule in this context is 1,6-hexanediol. Very particular preference is given to polycaprolactone diols prepared by polymerizing ε-caprolactone using 1,6-hexanediol as starter compound.

As linear polyol component (b2) it is also possible to use (co)polyethers formed from ethylene oxide, propylene oxide and/or tetrahydrofuran. Preference is given to polyethers having an average molecular weight of from 500 to 2000, such as polyethylene oxides or polytetrahydrofuran diols.

Also suitable as (b2) are hydroxyl-containing polycarbonates, preferably with an average molar weight of from 400 to 2000, such as hexanediol polycarbonate.

Suitable monofunctional linear polyethers (b3) are, for example, (co)polyethers formed from ethylene oxide and/or propylene oxide. Preference is given to polyalkylene oxide polyethers prepared starting from monoalcohol, with an average molar weight of from 350 to 2500 and with at least 70% of ethylene oxide units. Particular preference is given to (co)polymers having more than 75% of ethylene oxide units and a molar weight of from 300 to 2500, preferably from 500 to 1000. As starter molecules in the preparation of these polyethers it is preferred to use monofunctional alcohols having from 1 to 6 carbon atoms.

Suitable polyols (B3) are polyols having an OH functionality of greater than or equal to 2 and having average molar weights of from 300 to 5000, preferably from 300 to 3000, more preferably from 300 to 2000.

Preferred polyols (B3) are, for example, polyethers with an average molar weight of from 300 to 2000 and an average functionality of from 2.5 to 4 OH groups/molecule. Likewise preferred are polyesters with an average OH functionality of from 2.5 to 4.0. Suitable diols and dicarboxylic acids for the polyesters are those specified under component (b2), but they additionally include short-chain polyols with a functionality of three to six, such as trimethylolpropane, pentaerythritol or sorbitol. It is preferred to use polyester polyols based on adipic acid, phthalic acid, isophthalic acid and tetrahydrophthalic acid. Mixtures of different polyols or mixtures of diols and triols as well can be used.

Likewise suitable as component (B3) are (co)polyethers formed from ethylene oxide, propylene oxide and/or tetrahydrofuran with an average functionality of more than 2, and also branched polycarbonates.

As blocking agents (D) it is possible to use all known monofunctional blocking agents, such as ε-caprolactam, diethyl malonate, ethyl acetoacetate, oximes such as butanone oxime, diisopropylamine, dimethylpyrazole, triazole and mixtures thereof. Preference is given for example to ε-caprolactam, butanone oxime, diisopropylamine, 3,5-dimethylpyrazole, triazole and/or mixtures thereof.

For the process of the invention the reaction of component (A) with (B1) to form OH or NCO-functional prepolymers is of particular importance. This reaction should take place before all of the other components are added. If necessary, further isocyanate (A′) and/or (A″) to be employed ought likewise to take place after the preparation of the prepolymer. The preparation of the prepolymer can be carried out in the same reactor as the reaction with the other components to form the dispersions of the invention.

The process of the invention should be carried out so that in the reaction of components (A) and (B1) in accordance with the theoretical stoichiometric equation the level of unreacted excess components (A) and/or (B1) is minimal. The further reaction of the remaining components can take place in accordance with conventional methods of the state of the art.

Preference is given, however, to a process characterized in that in one step component (A) is reacted with component (B1), which includes at least one acid-functional compound (C), to form an NCO-functional or OH-functional prepolymer, then components (b1), (b2) and (b3) and, if desired, the isocyanate component (A′), which can be identical to or different from (A), are added, the resulting NCO-functional product is partly blocked with a blocking agent (D) and in a further stage a polyol component (B3) is added. With particular preference then, in a final stage, an acid-functional compound (C′), which may be identical to or different from (C), and an isocyanate component (A″), which may be identical to or different from (A) and (A′), are added.

The next event is the preparation of the aqueous dispersions comprising the self-crosslinking polyurethanes of the invention, by prior art processes.

The carboxylic acid groups present in the polyurethanes of the invention are neutralized to an extent of at least 50%, preferably from 80% to 120%, more preferably from 95 to 105%, with suitable neutralizing agents and the products are then dispersed with deionized water. Neutralization may take place before, during or after the dispersing or dissolving step. Neutralization prior to the addition of water, however, is preferred.

Suitable neutralizing agents are, for example, triethylamine, dimethylaminoethanol, dimethylcyclohexylamine, triethanolamine, methyldiethanolamine, diisopropanolamine, ethyldiisopropylamine, diisopropylcyclohexylamine, N-methylmorpholine, 2-amino-2-methyl-1-propanol, ammonia or other common neutralizing agents or their neutralizing mixtures. Preference is given to tertiary amines such as triethylamine, ethyldiisopropylamine and diisopropylhexylamine, and particular preference to dimethylethanolamine.

Likewise provided by the present invention are aqueous dispersions comprising the self-crosslinking polyurethanes of the invention. These aqueous dispersions find use as aqueous one-component baking systems.

In the process of the invention are from 5 to 60% by weight, preferably from 10 to 40% by weight, of the OH- and/or NCO-functional prepolymer, from 0 to 50% by weight, preferably from 5 to 40% by weight, more preferably from 10 to 25% by weight, of component (A′) and/or (A″), from 1 to 10% by weight, preferably from 1 to 5% by weight, of component (b1), from 5 to 40% by weight, preferably from 10 to 25% by weight, of component (b2), from 1 to 10% by weight, preferably from 1 to 5% by weight, of component (b3), from 10 to 60% by weight, preferably from 20 to 50% by weight, of component (B3), from 1 to 10% by weight, preferably from 1 to 5% by weight, of component (C′) and from 1 to 20% by weight, preferably from 1 to 10% by weight, of component (D), the sum of the components being 100%.

In order to regulate the viscosity it is possible if desired to add solvents as well to the reaction mixture. Suitable solvents are all known paint solvents such as N-methylpyrrolidone, methoxypropyl acetate or xylene, for example. They are used preferably in amounts of from 0 to 10% by weight, more preferably from 0 to 5% by weight. The solvent is preferably added during the polymerization.

It is also possible to add a relatively large amount of a (partly) water-miscible solvent such as acetone or methyl ethyl ketone to the reaction mixture. After the conclusion of the reaction water is added to the reaction mixture and the solvent is distilled off. This is also known as the acetone or slurry process. The advantage of this procedure lies in the low proportion of the solvent in the finished dispersion.

It is likewise possible to add catalysts to the reaction mixture. Preference is given to dibutyltin dilaurate and dibutyltin octoate.

The dispersions comprising the polyurethanes of the invention are used as one-component baking systems, containing free hydroxyl groups, for preparing varnishes, paints and other formulations. Any auxiliaries and additives of coating technology that are to be used as well, such as pigments, flow-control agents, bubble-preventing additives or catalysts, can be added likewise to the aqueous dispersions comprising the polyurethanes of the invention.

The invention also provides for the use of the dispersions comprising the polyurethanes of the invention for preparing paints, varnishes or adhesives.

The aqueous one-component coating compositions comprising the polyurethanes of the invention can be applied in one or more coats to any desired heat-resistance substrates by any desired methods of coating technology, such as spraying, brushing, dipping, flow coating or using rollers and doctor blades. The paint films generally have a dry film thickness of from 0.001 to 0.3 mm.

Examples of suitable substrates include metal, plastic, wood or glass. The paint film is cured at from 80 to 220° C., preferably from 120 to 180° C.

The aqueous one-component coating materials comprising the polyurethanes of the invention are suitable preferably for producing coatings and coating systems on steel sheets such as are used, for example, for producing vehicle bodywork, machines, panelling, drums or freight containers. Particular preference is given to the use of the aqueous one-component coating materials comprising the polyurethanes of the invention for preparing automotive surfacers and/or topcoat materials and/or primers.

The examples which follow show the advantages of the polyurethane dispersions of the invention over the prior art and also over the plain aliphatic and/or cycloaliphatic products.

### EXAMPLES

As polyisocyanates the following commercial products were used:
Desmodur®44 flakes: 4,4′-diisocyanatodiphenylmethane
Desmodur® T80: mixture of 80% 1,4- and 20% 1,6 diisocyanatotoluene
Desmodur® Z 4470 Mix: trimer of isophorone diisocyanate, 70% in methoxypropyl acetate/xylene

### Example 1

### Preparation of an Aromatic OH Prepolymer

321.96 g (2.4 mol) of dimethylolpropionic acid and 640.80 g of N-methylpyrrolidone were stirred in a stirring vessel at 50° C. until a clear solution formed (about 60 minutes). Then at 50° C. 397.50 (1.59 mol) of Desmodur® 44 flake product (Bayer AG, Leverkusen) were added and stirring was continued at 50° C. until according to IR spectroscopy NCO groups were no longer detectable (about 2 hours).

This gave a pale yellow liquid having a viscosity at 50° C. of 12 100 mPas. The reaction mixture contained 1.18 eq OH/kg.

### Example 2

### Preparation of a Cycloaliphatic NCO Prepolymer

697.6 g (5.20 mol) of dimethylolpropionic acid and 1388 g of N-methylpyrrolidone were stirred in a stirring vessel at 50° C. until a clear solution formed (60 minutes). Then at 50° C. 766.2 g (3.45 mol) of isophorone diisocyanate were added and the temperature was raised to 85° C. Stirring was continued at 85° C. for 6 hours; according to IR spectroscopy NCO groups were no longer detectable. The reaction mixture was then used directly for further syntheses; it contained 1.22 eq OH/kg.

### Example 3

170.03 g (0.20 eq OH) of compound from Example 1, 210.00 g (0.25 mol) of a polyester formed from adipic acid and 1,6-hexanediol with an average molar weight of 840, 25.0 g (0.05 mol) of a polyethylene oxide prepared starting from methanol and having an average molar weight of 500, 206.25 g (0.825 mol) of 4,4′-diisocyanatodiphenylmethane flakes (Desmodur® 44, Bayer AG, Leverkusen) were heated to 50° C. in a stirring vessel and mixed homogeneously. The mixture was stirred at 50° C. until an NCO value of 6.70% (calculated: 6.79%) was reached (180 minutes).

Then at 50° C. 69.70 g (0.80 mol) of butanone oxime were added over the course of 45 minutes, followed by 10 minutes' stirring. Subsequently 318.18 g (1.0 eq OH) of a polyester formed from adipic acid, isophthalic acid, trimethylolpropane, neopentyl glycol and propylene glycol with an OH number of 189 were added, the temperature was raised to 85° C. and the reaction mixture was stirred for 15 hours more. Thereafter, according to IR spectroscopy, NCO groups were no longer detectable. At 85° C. a solution of 23.60 (0.20 mol) of hydroxypivalic acid in 37.70 g of N-methylpyrrolidone and 144.0 g (0.4 eq NCO) Desmodur® Z 4470 M/X (Bayer AG Leverkusen) was added and the reaction mixture was stirred for 2 hours, after which it no longer contained any NCO groups.

Subsequently 44.60 g (0.50 mol) of dimethylethanolamine were added, stirring was continued for 10 minutes and then the product was dispersed with 1202.5 g of hot (50° C.) deionized water, with vigorous stirring, and the dispersion was stirred at 60° C. for one hour more and left to cool, with stirring.

The dispersion obtained had the following properties:

| | |
|---|---|
| Solids content: | 49.8% |
| Viscosity (rotational viscometer): | 2750 mPas |
| Particle size (laser correlation spectroscopy, LCS). | 77 nm |

### Example 4

### (Inventive)

170.03 g (0.20 eq OH) of compound from Example 1, 210.00 g (0.25 mol) of a polyester formed from adipic acid and 1,6-hexanediol with an average molar weight of 840, 25.00 g (0.05 mol) of a polyethylene oxide prepared starting from methanol and having an average molar weight of 500, 206.25 g (0.825 mol) of 4,4′-diisocyanatodiphenylmethane flakes (Desmodur® 44, Bayer AG, Leverkusen) and 36.00 g (0.1 eq NCO) of Desmodur® Z 4470 M/X Bayer AG, Leverkusen) were heated to 50° C. in a stirring vessel and mixed homogeneously. The mixture was stirred at 50° C. until an NCO value of 6.39% (calculated: 6.49%) was reached (140 minutes).

Then at 50° C. 80.95 g (0.80 mol) of diisopropylamine were added over the course of 15 minutes, followed by 10 minutes' stirring. Subsequently 318.20 g (1.0 eq OH) of a polyester formed from adipic acid, isophthalic acid, trimethylolpropane, neopentyl glycol and propylene glycol with an OH number of 189 were added, the temperature was raised to 85° C. and the reaction mixture was stirred for 90 minutes more. Thereafter, according to IR spectroscopy, NCO groups were no longer detectable. At 85° C. a solution of 23.60 g (0.20 mol) of hydroxypivalic acid in 37.70 g of N-methylpyrrolidone and 144.0 g (0.4 eq NCO) Desmodur® Z 4470 M/X (Bayer AG Leverkusen) was added and the reaction mixture was stirred for 2 hours, after which it no longer contained any NCO groups. Subsequently 44.60 g (0.50 mol) of dimethylethanolamine were added, stirring was continued for 10 minutes and then the product was dispersed with 1202.5 g of hot (50° C.) deionized water, with vigorous stirring, and the dispersion was stirred at 60° C. for one hour more and left to cool, with stirring

The dispersion obtained had the following properties:

| | |
|---|---|
| Solids content: | 42.6% |
| Viscosity (rotational viscometer): | 1950 mPas |
| Particle size (laser correlation spectroscopy, LCS): | 31 nm |

### Example 5

The procedure described in Example 4 was repeated but replacing 318.20 g (1.0 eq OH) of polyester formed from adipic acid, isophthalic acid, trimethylolpropane, neopentyl glycol and propylene glycol by 350.0 g (1.1 eq OH).

The dispersion obtained had the following properties:

| | |
|---|---|
| Solids content: | 49.4% |
| Viscosity (Haake-Rotavisco, 23° C.): | 660 mPas |
| Particle size (LCS): | 35 nm |

### Example 6

The procedure described in Example 4 was repeated but replacing 318.20 g (1.0 eq OH) of polyester formed from adipic acid, isophthalic acid, trimethylolpropane, neopentyl glycol and propylene glycol by 286.4 g (0.9 eq OH) and also using 91.10 g (0.9 mol) of diisopropylamine (instead of 80.95 g, 0.8 mol).

The dispersion obtained had the following properties:

| | |
|---|---|
| Solids content: | 49.7% |
| Viscosity (23° C., Haake-Rotavisco): | 670 mPas |
| Particle size (LCS) | 39 nm |

### Example 7

The procedure described in Example 4 was repeated but in the first reaction stage 231.25 g (1.85 eq NCO) of 4,4′-disocanatodiphenylmethane and additionally 6.71 g (0.1 eq OH) of trimethylolpropane, but no Desmodur Z 4470, were used. Also, in the penultimate reaction stage, Desmodur Z4470 M/X was replaced by 50 g (0.2 mol) of 4,4′-diisocyanatodiphenylmethane flakes (Desmodur® 44, Bayer AG, Leverkusen).

The dispersion had the following properties:

| | |
|---|---|
| Solids content: | 48.2% |
| Viscosity (23° C., Haake-Rotavisco): | 410 mPas |
| Particle size (LCS): | 31 nm |

### Example 8

40.24 g (0.3 mol) of dimethylolpropionic acid were dissolved in 80.10 g of N-methylpyrrolidone in a stirring apparatus at 50° C. Following the addition of 34.80 g (0.4 eq NCO) of Desmodur® T 80 (Bayer AG, Leverkusen) the mixture was stirred at 85° C. for 75 minutes; thereafter according to IR spectroscopy NCO groups were no longer detectable. The reaction mixture was cooled to 50° C. and 143.55 g (1.65 eq NCO) of Desmodur® T 80, 210.00 g (0.25 mol) of a polyester formed from adipic acid and 1,6-hexanediol with an average molar weight of 840 and 25.00 g (0.05 mol) of a polyethylene oxide prepared starting from methanol and having an average molar weight of 500 were added, and the mixture was stirred at 50° C. until an NCO value of 6.40% (calculated: 7.37%) was reached (140 minutes).

Then at 50° C. 80.95 g (0.80 mol) of diisopropylamine were added over the course of 45 minutes, followed by 10 minutes' stirring. Subsequently 318.20 g (1.0 eq OH) of a polyester formed from adipic acid, isophthalic acid, trimethylolpropane, neopentyl glycol and propylene glycol with an OH number of 189 were added, the temperature was raised to 85° C. and the reaction mixture was stirred for 90 minutes more. Thereafter according to IR spectroscopy NCO groups were no longer detectable.

At 85° C. a solution of 23.60 g (0.20 mol) of hydroxypivalic acid in 37.70 g of N-methylpyrrolidone and 144.0 g (0.4 eq NCO) of Desmodur® Z 4470 M/X (Bayer AG, Leverkusen) was added and the reaction mixture was stirred for 90 minutes, at which point it no longer contained any NCO groups. Subsequently 44.60 g (0.50 mol) of dimethylethanolamine were added, the mixture was stirred for 10 minutes more and then the product was dispersed with 1108 g of hot (50° C.) deionized water, with vigorous stirring, and the dispersion was stirred at 60° C. for 1 hour more and left to cool, with stirring.

The dispersion obtained had the following properties:

| | |
|---|---|
| Solids content: | 46.3% |
| Viscosity (23° C., rotational viscometer): | 600 mPas |
| Particle size (LCS): | 180 nm |

### Comparative example 1

### (Purely Aliphatic Polyurethane I)

The procedure described in Example 3 was repeated but using 164.60 g (0.2 eq OH) of compound from Example 2 instead of compound from Example 1 and using 183.50 g (1.75 eq NCO) of isophorone diisocyanate instead of Desmodur 44.

The dispersion obtained had the following properties:

| | |
|---|---|
| Solids content: | 53.8% |
| Viscosity (23° C., Haake-Rotavisco): | 1160 mPas |
| Particle size (LCS): | 141 nm |

### Comparative example 2

### (Purely Aliphatic Polyurethane II)

The procedure described in Example 4 was repeated but using 164.60 g (0.2 eq OH) of compound from Example 2 instead of compound from Example 1 and using 183.5 g (1.65 eq NCO) of isophorone diisocyanate instead of Desmodur 44.

The dispersion obtained had the following properties:

| | |
|---|---|
| Solids content: | 52.9% |
| Viscosity (23° C. Haake-Rotavisco): | 2950 mPas |
| Particle size (LCS): | 118 nm |

The following performance examples of clearcoat materials (Table 1) show the advantages of the compounds of the invention over the prior art and over polyurethanes synthesized on a purely aliphatic basic: the pendulum hardness is in each case higher and/or the solvent resistance (incipient dissolubility) is significantly better.

TABLE 1

| | Example No. | | | | | | | |
|---|---|---|---|---|---|---|---|---|
| | 9 | 10 | 11 | 12 | 13 | 14 | Comp. 1 | Comp. 2 |
| Dispersion from Example No. | 3 | 4 | 5 | 6 | 7 | 8 | Comp. 1 | Comp. 2 |
| Initial product mass (g) | 150.0 | 150.0 | 150.0 | 150.0 | 150.0 | 150.0 | 150.0 | 150.0 |
| Additol XW 395, as-supplied form | 1.3 | 1.2 | 1.3 | 1.3 | 1.3 | 1.2 | 1.4 | 1.4 |
| Surfynol 104, 50% in NMP | 1.3 | 1.2 | 1.3 | 1.3 | 1.3 | 1.2 | 1.4 | 1.4 |
| DMEA, 10% in water | 1.3 | — | — | — | — | | 1.4 | 0.8 |
| Distilled water | 19.4 | 7.9 | 13.9 | 15.1 | 8.0 | 15.2 | 19.0 | 23.1 |
| Total | 173.3 | 160.3 | 166.5 | 167.5 | 160.6 | 167.6 | 173.2 | 176.7 |
| Solids (%) | 43.1 | 43.6 | 44.5 | 44.5 | 44.9 | 37.6 | 46.6 | 44.9 |
| Efflux time ISO 5 mm (s) | 41 | 40 | 38 | 38 | 40 | 40 | 40 | 35 |
| pH | 8.3 | 9.4 | 9.1 | 9.2 | 9.4 | 9.0 | 8.3 | 8.3 |
| Baking conditions 10 min. RT + | | | | | | | | |
| 30 min. 140° C. | | | | | | | | |
| Pendulum hardness (s) | 127 | 158 | 147 | 161 | 150 | 130 | 90 | 97 |
| Incipient dissolubility 1 min. (0-5) | 3444 | 2344 | 3344 | 2344 | 2244 | 4444 | 4444 | 4444 |
| Coating film appearance | sat.¹⁾ | sat. | sat. | sat. | sat. | sat. | sat. | sat. |
| Baking conditions 10 min. RT + | | | | | | | | |
| 30 min. 160° C. | | | | | | | | |
| Pendulum hardness (s) | 140 | 170 | 174 | 188 | 162 | 152 | 118 | 144 |
| Incipient dissolubility 1 min. (2) (0-5) | 2344 | 1244 | 1233 | 1233 | 1134 | 2344 | 3344 | 3244 |
| Coating film appearance | sat. | sat. | sat. | sat. | sat. | sat. | sat. | sat. |

¹⁾sat. = satisfactory, flawless
(2) solvent sequence: toluene, methoxypropyl acetate, ethyl acetate, acetone; assessment: 0 very good to 5 poor

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for preparing self-crosslinking polyurethane polymers
comprising reacting an aromatic isocyanate component (A) or a mixture of aromatic, aliphatic and/or cycloaliphatic isocyanate component having an isocyanate group functionality of greater than or equal to 2 with an at least difunctional polyol component (B1) with an average molecular weight of from 62 to 2500, which includes at least one acid-functional compound (C), to give a prepolymer containing isocyanate groups or containing hydroxyl groups,
adding one or more polyol components (B2) having an OH functionality of greater than or equal to 1, and optionally, an isocyanate component (A′), which may be identical to or different from (A),
mixing the resulting NCO-functional product with a blocking agent (D), and
adding a polyol component (B3).

2. The process according to claim 1, wherein component (A) is reacted in one step with component (B1), which includes at least one acid-functional compound (C), to give an NCO-functional prepolymer, subsequently adding components (b1), (b2) and (b3) and, optionally isocyanate component (A′), which may be identical to or different from (A), partially blocking the resulting NCO-functional product with a blocking agent (D), and adding a polyol component (B3).

3. The process according to claim 1, wherein following the addition of the polyol component (B3) in a final step adding an acid-functional compound (C′), which may be identical to or different from (C), and an isocyanate component (A″), which may be identical to or different from (A) and (A′).

4. The process according to claim 1, wherein the isocyanate component (A)/(A′)/(A″) is tolylene diisocyanate, diphenylmethane 2,4′- and/or 4,4′-diisocyanate.

5. The process according to claim 1, wherein the polyol component (B1) comprises dihydric to hexahydric polyol components with a molecular weight of from 62 to 2500, at least one of these components being an acid-functional compound (C).

6. The process according to claim 1, wherein the acid-functional compound (C)/(C′) is 3-hydroxy-2,2-dimethylpropanoic acid (hydroxypivalic acid) or dimethylolpropionic acid.

7. The process according to claim 1, wherein the polyol component (B2) is selected from the group consisting of
b1) dihydric to hexahydric alcohols having average molar weights of from 62 to 300,
b2) linear difunctional polyols having average molar weights of from 300 to 4000,
b3) monofunctional linear polyethers having average molar weights of from 300 to 3000.

8. The process according to claim 1, wherein the polyol components (B3) comprise polyols having an OH functionality of more than 2 and average molar weights of from 300 to 5000.

9. The process according to claim 8, characterized in that the polyol components (B3) are polyethers or polyesters having an average functionality of from 2.5 to 4 OH groups/molecule.

10. Self-crosslinking polyurethane polymers prepared according to claim 1.

11. An aqueous dispersion comprising the self-crosslinking polyurethanes obtained according to claim 1.

12. A method of preparing aqueous dispersions comprising neutralizing the polyurethane polymers according to claim 10.

13. A paint, varnish or adhesive composition comprising the polyurethane polymers according to claim 10.

14. The process according to claim 2, wherein following the addition of the polyol component (B3) in a final step adding an acid-functional compound (C′), which may be identical to or different from (C), and an isocyanate component (A″), which may be identical to or different from (A) and (A′).

15. The process according to claim 2, wherein the isocyanate component (A)/(A′)/(A″) is tolylene diisocyanate, diphenylmethane 2,4′- and/or 4,4′-diisocyanate.

16. The process according to claim 3, wherein the isocyanate component (A)/(A′)/(A″) is tolylene diisocyanate, diphenylmethane 2,4′- and/or 4,4′-diisocyanate.

17. The process according to claim 2, wherein the polyol component (B1) comprises dihydric to hexahydric polyol components with a molecular weight of from 62 to 2500, at least one of these components being an acid-functional compound (C).

18. The process according to claim 3, wherein the polyol component (B1) comprises dihydric to hexahydric polyol components with a molecular weight of from 62 to 2500, at least one of these components being an acid-functional compound (C).

19. The process according to claim 4, wherein the polyol component (B1) comprises dihydric to hexahydric polyol components with a molecular weight of from 62 to 2500, at least one of these components being an acid-functional compound (C).

20. The process according to claim 2, wherein the acid-functional compound (C)/(C′) is 3-hydroxy-2,2-dimethylpropanoic acid (hydroxypivalic acid) or dimethylolpropionic acid.

21. The process according to claim 3, wherein the acid-functional compound (C)/(C′) is 3-hydroxy-2,2-dimethylpropanoic acid (hydroxypivalic acid) or dimethylolpropionic acid.

22. The process according to claim 4, wherein the acid-functional compound (C)/(C′) is 3-hydroxy-2,2-dimethylpropanoic acid (hydroxypivalic acid) or dimethylolpropionic acid.

23. The process according to claim 5, wherein the acid-functional compound (C)/(C′) is 3-hydroxy-2,2-dimethylpropanoic acid (hydroxypivalic acid) or dimethylolpropionic acid.

24. The process according to claim 2, wherein the polyol component (B2) is selected from the group consisting of
b1) dihydric to hexahydric alcohols having average molar weights of from 62 to 300,
b2) linear difunctional polyols having average molar weights of from 300 to 4000,
b3) monofunctional linear polyethers having average molar weights of from 300 to 3000.

25. The process according to claim 3, wherein the polyol component (B2) is selected from the group consisting of
b1) dihydric to hexahydric alcohols having average molar weights of from 62 to 300,
b2) linear difunctional polyols having average molar weights of from 300 to 4000,
b3) monofunctional linear polyethers having average molar weights of from 300 to 3000.

26. The process according to claim 4, wherein the polyol component (B2) is selected from the group consisting of
b1) dihydric to hexahydric alcohols having average molar weights of from 62 to 300,
b2) linear difunctional polyols having average molar weights of from 300 to 4000,
b3) monofunctional linear polyethers having average molar weights of from 300 to 3000.

27. The process according to claim 5, wherein the polyol component (B2) is selected from the group consisting of
b1) dihydric to hexahydric alcohols having average molar weights of from 62 to 300,
b2) linear difunctional polyols having average molar weights of from 300 to 4000,
b3) monofunctional linear polyethers having average molar weights of from 300 to 3000.

28. The process according to claim 6, wherein the polyol component (B2) is selected from the group consisting of
b1) dihydric to hexahydric alcohols having average molar weights of from 62 to 300,
b2) linear difunctional polyols having average molar weights of from 300 to 4000,
b3) monofunctional linear polyethers having average molar weights of from 300 to 3000.

29. The process according to claim 2, wherein the polyol components (B3) comprise polyols having an OH functionality of more than 2 and average molar weights of from 300 to 5000.

30. The process according to claim 3, wherein the polyol components (B3) comprise polyols having an OH functionality of more than 2 and average molar weights of from 300 to 5000.

31. The process according to claim 4, wherein the polyol components (B3) comprise polyols having an OH functionality of more than 2 and average molar weights of from 300 to 5000.

32. The process according to claim 5, wherein the polyol components (B3) comprise polyols having an OH functionality of more than 2 and average molar weights of from 300 to 5000.

33. The process according to claim 6, wherein the polyol components (B3) comprise polyols having an OH functionality of more than 2 and average molar weights of from 300 to 5000.

34. The process according to claim 7, wherein the polyol components (B3) comprise polyols having an OH functionality of more than 2 and average molar weights of from 300 to 5000.
